(19) United States
(12) Patent Application Publication
(10) Pub. No.: US 2025/0074514 A1
(43) Pub. Date: Mar. 6, 2025

(54) STRUCTURAL COMPONENT AND METHOD FOR PRODUCING A STRUCTURAL COMPONENT

(71) Applicant: ElringKlinger AG, Dettingen (DE)

(72) Inventors: Gerd TRAXLER, Weilheim Teck (DE); Marco SCHRADE, Hayingen (DE)

(73) Assignee: ElringKlinger AG, Dettingen (DE)

(21) Appl. No.: 18/950,010

(22) Filed: Nov. 16, 2024

Related U.S. Application Data
(63) Continuation of application No. PCT/EP2023/063509, filed on May 19, 2023.

(30) Foreign Application Priority Data
May 20, 2022 (DE) 10 2022 112 720.6

(51) Int. Cl. B62D 25/14; B21K 21/00

(52) U.S. Cl. CPC B62D 25/145; B21K 21/00

(57) ABSTRACT

In order to provide a structural component, in particular a cockpit cross-member for a motor vehicle, which can be produced simply and cost-effectively, according to the invention the structural component comprises the following: a profile element which has a peripheral wall that delimits an interior of the profile element at least in regions, and at least one through opening provided in the peripheral wall of the profile element; at least one fastening element which is arranged in the interior of the profile element so as to correspond to the at least one through opening; and at least one pressure-forming portion which is formed on the profile element and/or on the fastening element and positions the fastening element with respect to the through opening.

### RELATED APPLICATION

This application is a continuation of international application No. PCT/EP2023/063509 filed on May 19, 2023, and claims the benefit of German application No. 10 2022 112 720.6 filed on May 20, 2022, which are incorporated herein by reference in their entirety and for all purposes.

### FIELD OF DISCLOSURE AND BACKGROUND

The present invention relates to a structural component, in particular a cockpit cross-member for a motor vehicle, and a method for producing a structural component.

### SUMMARY OF THE INVENTION

The object of the present invention is to provide a structural component, in particular a cockpit cross-member for a motor vehicle, which can be produced in a simple and cost-effective manner.

This object is achieved according to the invention by a structural component, in particular a cockpit cross-member for a motor vehicle, wherein the structural component comprises: a profile element which has a peripheral wall that delimits an interior of the profile element at least in regions, and at least one through opening provided in the peripheral wall of the profile element, at least one fastening element which is arranged in the interior of the profile element so as to correspond to the at least one through opening, and at least one forming portion which is formed on the profile element and/or on the fastening element and positions the fastening element with respect to the through opening.

The profile element preferably is a tubular element or a hollow profile.

Preferably, the profile element can be configured from a metal material, in particular from a light metal, for example aluminum or magnesium.

The profile element can also be configured from a polymer material, preferably as a plastics molded part. Such a plastics molded part can be configured, for example, as an injection-molded part or as an extrusion component.

Alternatively, the profile element can also be configured from a composite material.

The structural component, in particular the cockpit cross-member, can be a polymer-metal hybrid component. In other words, it can be a component which is configured from a combination of a polymer material and a metal material.

The at least one through opening can preferably be introduced by drilling, milling, cutting, stamping or the like, in the peripheral wall of the profile element.

The at least one fastening element, in particular, is a component which is designed for fastening further components, elements, structures or the like, to the structural component.

The at least one fastening element can have an insertion portion, a threaded portion, a latching portion or the like, for configuring a connecting arrangement with one or more further components, elements or structures.

A development of the structural component can provide that the at least one forming portion acts on and/or engages in the at least one fastening element and/or the profile element.

Since the at least one forming portion acts on and/or engages in the at least one fastening element and/or the profile element, a fixed positioning of the fastening element can be formed with respect to the through opening.

The at least one forming portion can be configured in such a manner that it bears against the at least one fastening element and/or against the profile element. As a result, the fastening element can be prevented from slipping in the interior of the profile element in at least one direction.

The profile element and the at least one fastening element can be formed together at least in some portions. In this manner, the at least one forming portion can be configured by a positive connection between the profile element and the at least one fastening element.

In a preferred embodiment of the structural component, it can be provided that the at least one forming portion is configured by plastic forming of a material reservoir provided on the profile element and/or on the at least one fastening element.

Due to the provision of such a material reservoir, a material portion which permits the forming can be provided on the profile element and/or on the fastening element.

Preferably, the material reservoir is configured by the profile element and/or the fastening element.

Due to the provision of such a material reservoir, it is possible to prevent a structural impairment of the profile element and/or the fastening element by the forming process, for example an impairment of the strength.

Preferably, in the structural component it can be provided that the material reservoir is configured for forming the at least one forming portion on an edge region of the profile element delimiting the through opening.

The material reservoir can be configured, for example, as a material tab which extends into the through opening from the edge region of the profile element surrounding the through opening.

In an advantageous development of the structural component, the material reservoir can be configured as a projecting portion which is configured by the peripheral wall of the profile element.

The at least one projecting portion forming the material reservoir can preferably be configured in a plane of the peripheral wall of the profile element and extend into the through opening from the edge region of the profile element, in particular in the plane of the peripheral wall.

Preferably, the material reservoir can have a material thickness which corresponds to a material thickness of the peripheral wall of the profile element. This can permit a simple manufacture of the material reservoir.

Alternatively, the material reservoir can have a material thickness which is configured to be greater than a material thickness of the peripheral wall of the profile element. As a result, a sufficient quantity of material can be provided for the forming process.

The material reservoir can also have a material thickness which is configured to be smaller than a material thickness of the peripheral wall of the profile element. Due to the smaller material thickness of the material reservoir it can be achieved that a smaller forming force is required for forming the material reservoir.

Particularly preferably, the structural component can be provided such that a plurality of material reservoirs which are spaced apart from one another are configured on the profile element and/or the at least one fastening element, in particular on the edge region of the profile element surrounding the through opening, for configuring a plurality of forming portions.

In particular, four material reservoirs which are spaced apart from one another can be provided on the profile element and/or the at least one fastening element, in particular on the edge region of the profile element surrounding the through opening.

In each case, two material reservoirs can be arranged opposing one another on the profile element and/or the at least one fastening element, in particular on the edge region of the profile element surrounding the through opening.

A fastening of the fastening element in the interior of the profile element can be configured by the plurality of, in particular four, forming portions.

In particular, a fixed positioning of the fastening element with respect to the at least one through opening of the profile element can be configured by the plurality of, in particular four, forming portions.

Advantageously, in the structural component it can be provided that the at least one forming portion extends from the peripheral wall of the profile element in the direction of the interior of the profile element.

Preferably, the at least one forming portion protrudes relative to an internal wall of the profile element in the direction of the interior of the profile element.

The at least one forming portion can advantageously extend substantially at right-angles from the internal wall of the profile element in the direction of the interior of the profile element.

The forming portion can extend, for example, 20 mm or less, preferably 10 mm or less, from the internal wall of the profile element in the direction of the interior of the profile element.

In one embodiment of the structural component, the at least one fastening element can have a sleeve-shaped base body and extend between opposing internal walls of the profile element.

In this manner, the at least one fastening element can be supported on the opposing internal walls and reinforce a structural strength of the structural component.

The at least one fastening element can have any cross-sectional geometry. For example, the fastening element can have a round, angled or oval cross-sectional geometry or a substantially rectangular geometry with rounded corner regions.

The sleeve-shaped base body of the fastening element preferably has a hollow space in which, for example, an insertion portion, a threaded portion, a latching portion or the like, is provided for a connecting arrangement.

Preferably, in the structural component it can be provided that an internal cross section of the at least one through opening is configured at least in some regions to be smaller than a cross section of the fastening element, and the fastening element which is positioned with respect to the through opening bears at least in some regions against an internal wall portion of the profile element surrounding the through opening.

In particular, the sleeve-shaped fastening element bears over the entire periphery against the internal wall portion of the profile element surrounding the through opening and/or is supported thereagainst.

Preferably, a free internal cross section of the fastening element is identical at least approximately and/or at least in some portions to the free internal cross section of the at least one through opening.

Preferably, it can be provided that the edge region delimiting the at least one through opening and an inner surface of the fastening element, in particular the sleeve-shaped fastening element, are configured at least in some portions to be aligned with one another.

Advantageously, in the structural component it can be provided that the profile element has at least one further through opening in the peripheral wall of the profile element opposing the at least one through opening.

The at least one further through opening can be configured in an equivalent manner to the at least one through opening. In particular, a free internal cross section of the at least one through opening and the opposing at least one further through opening can be configured in an equivalent manner to one another.

The at least one through opening and the opposing at least one further through opening can be oriented so as to be aligned with one another.

In a development of the structural component, an internal cross section of the at least one further through opening can be configured at least in some regions to be smaller than a cross section of the fastening element, and the fastening element can bear at least in some regions against an internal wall portion of the profile element surrounding the at least one further through opening.

In particular, the sleeve-shaped fastening element bears over the entire periphery against the internal wall portion of the profile element surrounding the at least one through opening and/or is supported thereon.

Preferably, a free internal cross section of the fastening element is identical at least approximately and/or at least in some portions to the free internal cross section of the at least one further through opening.

Preferably, it can be provided that the edge region delimiting the at least one further through opening and the inner surface of the fastening element, in particular the sleeve-shaped fastening element, are configured at least in some portions so as to be aligned with one another.

In one embodiment of the structural component, the at least one further through opening can have an opening cross section through which the at least one fastening element can be introduced into the interior of the profile element.

The free internal cross section of the at least one further through opening can be configured to be slightly larger than the cross section of the fastening element.

Particularly preferably, in the structural component it can be provided that the profile element is an internal high pressure-formed tubular element.

Since the profile element is configured by an internal high pressure method, this profile element can also have complex cross-sectional geometries in the longitudinal extent in addition to a linear cross-sectional geometry.

Such an internal high pressure-formed tubular element is preferably configured from a metal material, in particular from a light metal, for example aluminum or magnesium.

The object is also achieved by a method for producing a structural component, in particular a structural component according to one of the above-described embodiments, wherein the method comprises the steps: providing a profile element which has a peripheral wall which at least in some regions delimits an interior of the profile element, and at least one through opening which is provided in the peripheral wall of the profile element, introducing at least one fastening element into the interior of the profile element and orienting the fastening element with respect to the at least one through opening, forming at least one material reservoir configured on the profile element and/or on the fastening element for forming a forming portion which positions the fastening element with respect to the through opening.

Preferably, in the method it can be provided that the at least one fastening element is introduced, in particular is inserted, laterally into the interior of the profile element, is oriented with respect to the at least one through opening and is positioned by configuring the at least one forming portion with respect to the through opening.

In an alternative embodiment of the method, the at least one fastening element can be introduced on one side through a further through opening in the peripheral wall into the interior of the profile element, oriented with respect to the at least one through opening and positioned with respect to the at least one through opening by configuring the at least one forming portion.

A development of the method can also have the steps: introducing a forming tool into the at least one through opening, plastic forming of the at least one material reservoir by introducing the forming tool into the at least one through opening, configuring the forming portion by plastic forming of the material reservoir, wherein the forming portion is configured so as to extend from the peripheral wall of the profile element in the direction of the interior of the profile element.

Preferably, the forming tool is a forming die which can be inserted through the at least one through opening into a hollow space of the fastening element.

A plurality of forming elements corresponding to the material reservoirs provided on the profile element are configured on the forming tool, the forming of the material reservoirs taking place thereby to form the forming portions.

Further preferred features and/or advantages of the invention form the subject matter of the following description and the illustrated view of exemplary embodiments.

### BRIEF DESCRIPTION OF THE DRAWINGS

FIG. 1 shows a schematic perspective view of a profile element for an embodiment of a structural component according to the invention;

FIG. 2 shows a schematic perspective view of the profile element in FIG. 1 with a fastening element introduced into the profile element;

FIG. 3 shows a schematic perspective view of a forming tool for configuring the structural component;

FIG. 4 shows a schematic perspective view of the forming tool in FIG. 3 during a forming process for configuring the structural component;

FIG. 5 shows a sectional view of the forming tool during the forming process according to FIG. 4;

FIG. 6 shows a schematic perspective view of an embodiment of the structural component according to the invention.

Elements which are the same or functionally equivalent are provided in all of the figures with the same reference signs.

### DETAILED DESCRIPTION OF THE DRAWINGS

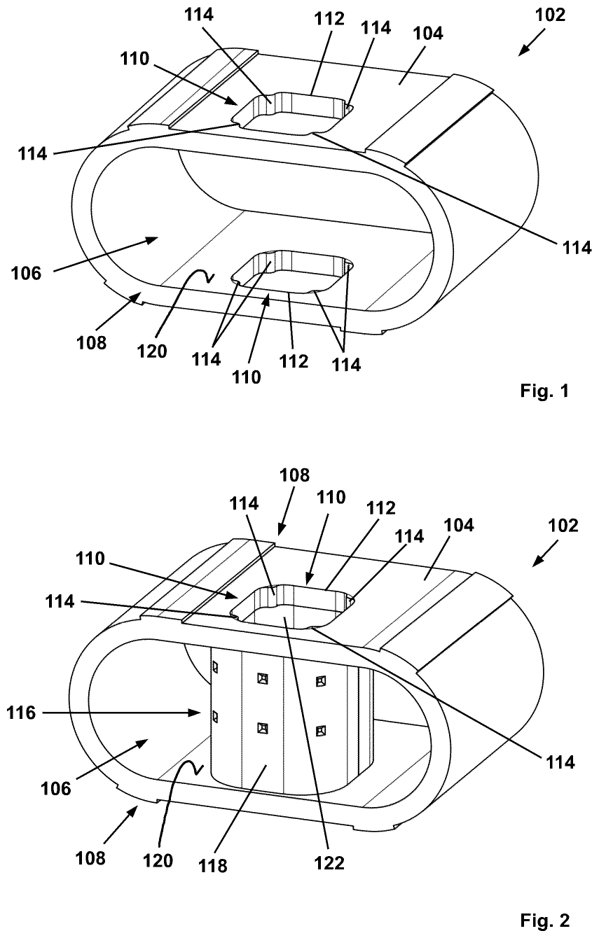

FIG. 1 shows a schematic view of a profile element 102 of a structural component, shown as a whole in FIG. 6 and denoted by 100. This structural component 100 can preferably be a cockpit cross-member for a motor vehicle.

A partial region of the profile element 102 is shown in FIG. 1. The profile element 102 extends in a longitudinal direction of extent. Preferably, the profile element 102 is configured as a tubular element or a hollow profile.

The profile element 102 is particularly preferably an internal high pressure-formed tubular element.

Such an internal high pressure-formed profile element 102 can have a variable cross-sectional geometry along the longitudinal extent of the profile element 102. The cross-sectional geometry of the profile element 102 can be adapted according to an embodiment of a forming tool in a flexible manner to an application field of the structural component 100.

A diameter of the profile element 102 can be, for example, 200 mm or less, preferably 100 mm or less.

The structural component 100, in particular when used as a cockpit cross-member for a motor vehicle, can preferably be configured as a polymer-metal hybrid component. As such, the structural component 100 is configured from a combination of a polymer material and a metal material.

In particular, the profile element 102 is configured from a metal material, preferably from a light metal, for example aluminum or magnesium.

Alternatively, the profile element 102 can also be configured from a polymer material or from a composite material.

The profile element 102 comprises a peripheral wall 104 which at least in some regions delimits an interior 106 of the profile element 102.

The peripheral wall 104 of the profile element 102 preferably has a material thickness of 10 mm or less, particularly preferably a material thickness of 5 mm or less.

The material thickness of the peripheral wall 104 can vary over the longitudinal extent and/or peripheral extent of the profile element 102. For example, the material thickness of the peripheral wall 104 can be configured to be thicker in the regions of the profile element 102 which require a high strength than in the other regions of the profile element 102.

The peripheral wall 104 delimits the interior 106 of the profile element 102, preferably over the entire periphery.

An inlet opening 108, through which an access to the interior 106 of the profile element 102 is formed, is configured on at least one end of the profile element 102, preferably on both ends of the profile element 102.

At least one through opening 110 is configured in the peripheral wall 104 of the profile element 102.

The at least one through opening 110 can preferably be introduced by drilling, milling, cutting, stamping or the like, into the peripheral wall 104 of the profile element 102.

In particular, the profile element 102 has a plurality of through openings 110 which are spaced apart from one another in the longitudinal extent thereof.

As shown in FIG. 1, preferably in each case two through openings 110 are provided opposingly in the peripheral wall 104 of the profile element 102.

The opposing through openings 110 can be oriented, in particular, so as to be aligned with one another.

The through opening 110 can have a substantially rectangular opening cross section. Alternatively, the through opening 110 can have any other opening cross section, for example a round or oval opening cross section.

A plurality of material reservoirs 114 which are spaced apart from one another are configured on an edge region 112 of the profile element 102 surrounding the through opening 110.

Preferably, four material reservoirs 114 are configured on the edge region 112 of the profile element 102 surrounding the through opening 110.

More than four or even fewer than four material reservoirs 114 can also be provided on the edge region 112 surrounding the through opening 110.

The material reservoirs 114 are preferably configured in each case as a projecting portion which is configured by the peripheral wall 104 of the profile element 102.

The material reservoirs 114 can form tab-shaped projections.

Each of these material reservoirs 114 provides material in order to configure a forming portion in each case by a forming process described below in more detail.

According to the embodiment of the profile element 102 shown in FIG. 1, the material reservoirs 114 are arranged in each case in a corner region of the substantially rectangular through opening 110.

The material reservoirs 114 can also be arranged in each case at any other point on the edge region 112 of the through opening 110.

Preferably, two material reservoirs 114 are arranged in each case opposingly on the edge region 112 of the through opening 110.

The material reservoirs 114 preferably extend into the through opening 110 from the edge region 112 delimiting the through opening 110.

In particular, the material reservoirs 114 extend in a plane of the peripheral wall 104 of the profile element 102.

The material reservoirs 114 can preferably have the same material thickness as the wall thickness of the peripheral wall 104 of the profile element 102.

FIG. 2 shows the profile element 102 with a fastening element 116 introduced into the interior 106.

The fastening element 116, in particular, is a component for fastening further components, elements or structures to the structural component 100.

If the profile element 102 has a plurality of through openings 110 which are spaced apart from one another, preferably a plurality of fastening elements 116 can be introduced into the interior 106 and oriented with respect to the respective through openings 110.

The fastening element 116 is preferably introduced into the interior 106 of the profile element 102 via one of the inlet openings 108 at the ends of the profile element 102.

In an alternative embodiment of the profile element 102, it can also be provided that one of the through openings 110 has an opening cross section which is configured to be slightly larger than a cross section of the fastening element 116 so that the fastening element 116 can be inserted into the interior 106 through one of the through openings 110.

The fastening element 116 has a sleeve-shaped base body 118 which extends between the opposing internal walls 120 of the profile element 102.

A hollow space 122 of the fastening element 116 preferably has an insertion portion, a threaded portion, a latching portion or the like, in order to connect one or more components, elements or structures to the structural element 100.

The fastening element 116 has a substantially rectangular cross-sectional geometry with rounded corner regions. The fastening element 116, however, can also have any other cross-sectional geometry, for example a round, angled or oval cross-sectional geometry.

The fastening element 116 is oriented corresponding to the through openings 110. As a result, the hollow space 122 of the fastening element 116 is accessible via the through openings 110.

Preferably, a free internal cross section of the through openings 110 is configured to be smaller than a cross section of the fastening element 116, so that the fastening element 116 which is oriented with respect to the through opening 110 bears against an internal wall portion of the profile element 102 surrounding the through opening 110.

The free internal cross section of the fastening element 116 can preferably be configured to be identical at least approximately and/or at least in some portions to the free internal cross section of the through opening 110.

In particular, an inner surface of the sleeve-shaped fastening element 116 and the edge region 112 delimiting the through opening 110 are configured at least in some portions to be aligned with one another.

The material reservoirs 114 protrude relative to the inner surface of the sleeve-shaped fastening element 116 from the edge region 112 delimiting the through opening 110. In this manner, the material reservoirs 114 can be formed by the forming process in the hollow space 122 of the fastening element 116.

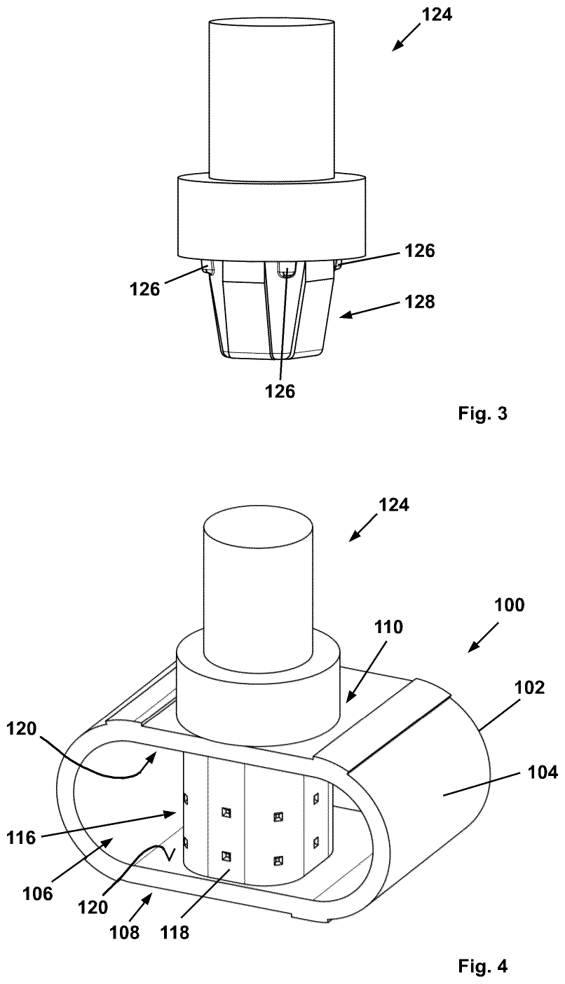

FIG. 3 shows a forming tool 124 for performing this forming process. The forming tool 124, in particular, is part of a tool apparatus, not shown in more detail, for the automatic or semi-automatic manufacture of the structural component 100.

The forming tool 124 is preferably configured as a forming die.

The forming tool 124 comprises a plurality of forming elements 126 which are provided corresponding to the material reservoirs 114 configured on the profile element 102.

Preferably, the forming tool 124 comprises an insertion portion 128, the forming elements 126 being configured on the outer periphery thereof.

For producing the structural component 100 the fastening element 116 is initially introduced into the interior 106 of the profile element 102, in particular via one of the inlet openings 108 or via a correspondingly designed through opening 110. Then the fastening element 116 is oriented with respect to the two through openings 110.

Then, for performing the forming process, the forming tool 124, as shown in FIG. 4, is inserted with the forming elements 126, in particular with the insertion portion 128 on which the forming elements 126 are configured, in such a manner into the through opening 110 of the profile element 102 that the forming elements 126 are brought into contact in each case with the corresponding material reservoirs 114.

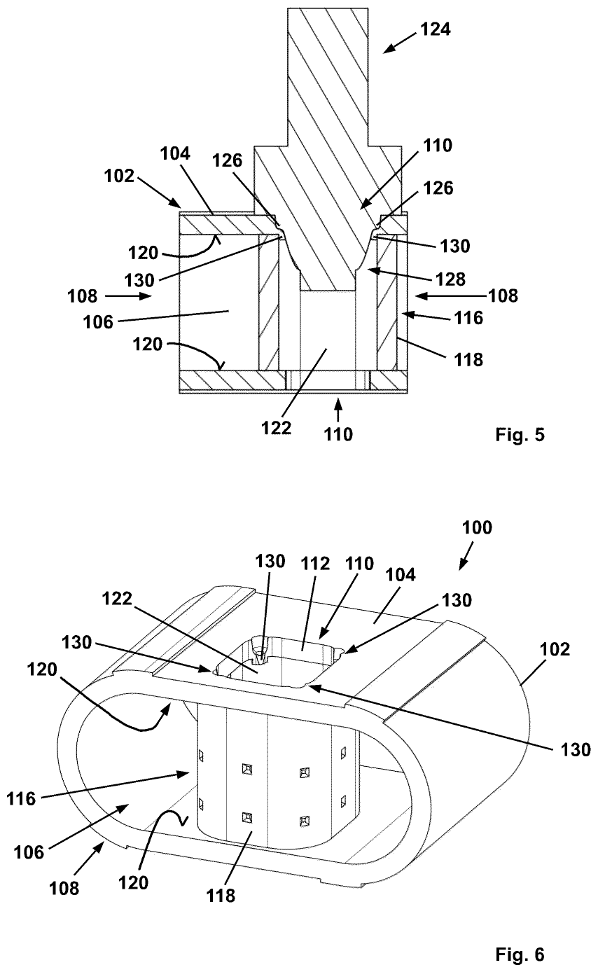

FIG. 5 illustrates in a sectional view the forming of the material reservoirs 114 by the forming tool 124. Due to the forming process, the material reservoirs 114 on the profile element 102 are formed in each case to form a forming portion 130.

In order to configure the forming portions 130, the forming elements 126 of the forming tool 124 are initially brought into abutment with the material reservoirs 114 by lowering the forming tool 124. The material reservoirs 114 are then formed by plastic forming in the direction of the interior 106 of the profile element 102 by lowering the forming tool 124 further.

The forming portions 130 are configured by forming the material reservoirs 114 in such a manner that the forming portions 130 extend from the peripheral wall 104 of the profile element 102 in the direction of the interior 106 of the profile element 102.

In particular, the forming portions 130 are configured in such a manner that they extend into the hollow space 122 of the fastening element 116 positioned with respect to the through opening 110.

The forming portions 130 preferably engage in the fastening element 116 or act on the fastening element 116.

It is provided that the forming portions 130 bear against an internal wall 132 of the fastening element 116 so that the fastening element 116 is fastened in the interior 106 of the profile element 102, i.e. is fastened in a fixed position with respect to the through openings 110.

The forming portions 130 can extend, for example, 20 mm or less, preferably 10 mm or less, from the internal wall 120 of the profile element 102 in the direction of the interior 108 of the profile element 102, in particular into the hollow space 122 of the fastening element 116.

Alternatively, it can be provided that the material reservoirs 114 on the profile element 102, and at least in some regions the fastening element 116, are formed together by the forming tool 124, so that a positive connection is formed between the profile element 102 and the fastening element 116. In this manner, the fastening element 116 can also be positioned in the interior 106 of the profile element 102 in a fixed manner with respect to the through openings 110.

In addition, the above-described forming process can also be performed by the forming tool 124 on the correspondingly designed opposing through opening 110.

The fully configured structural component 100 is shown in FIG. 6. FIG. 6 illustrates, in comparison with FIG. 2, how the material reservoirs 114 which are configured on the edge region 112 of the through opening 110 are formed into the forming portions 130.

The forming portions 130 extend in a projection-like manner into the hollow space 122 of the fastening element 116. Since the forming portions 130 are arranged in such a manner that they bear against, act on and/or engage in the fastening element 116 at four positions, the fastening element 116 is fastened in the interior 106 of the profile element 102 in a fixed position with respect to the through openings 110.

### LIST OF REFERENCE SIGNS

100 Structural component
102 Profile element
104 Peripheral wall
106 Interior
108 Inlet opening
110 Through opening
112 Edge region
114 Material reservoir
116 Fastening element
118 Base body
120 Internal wall of profile element
122 Hollow space
124 Forming tool
126 Forming element
128 Insertion portion
130 Forming portion

1. A structural component, optionally a cockpit cross-member for a motor vehicle, comprising:
a profile element which has a peripheral wall that delimits an interior of the profile element at least in regions, and at least one through opening provided in the peripheral wall of the profile element,
at least one fastening element which is arranged in the interior of the profile element so as to correspond to the at least one through opening, and
at least one forming portion which is formed on the profile element and/or on the fastening element and positions the fastening element with respect to the through opening.

2. The structural component as claimed in claim 1, wherein the at least one forming portion acts on and/or engages in the at least one fastening element and/or the profile element.

3. The structural component as claimed in claim 1, wherein the at least one forming portion is configured by plastic forming of a material reservoir provided on the profile element and/or on the fastening element.

4. The structural component as claimed in claim 3, wherein the material reservoir is configured for forming the at least one forming portion on an edge region of the profile element surrounding the through opening.

5. The structural component as claimed in claim 3, wherein the material reservoir is configured as a projecting portion which is configured by the peripheral wall of the profile element.

6. The structural component as claimed in claim 3, wherein a plurality of material reservoirs which are spaced apart from one another are configured on the profile element and/or the at least one fastening element, optionally on the edge region of the profile element delimiting the through opening, for configuring a plurality of forming portions.

7. The structural component as claimed in claim 1, wherein the at least one forming portion extends from the peripheral wall of the profile element in the direction of the interior of the profile element.

8. The structural component as claimed in claim 1, wherein the at least one fastening element has a sleeve-shaped base body and extends between the opposing internal walls of the profile element.

9. The structural component as claimed in claim 1, wherein an internal cross section of the at least one through opening is configured at least in some regions to be smaller than a cross section of the fastening element, and the fastening element which is positioned with respect to the through opening bears at least in some regions against an internal wall portion of the profile element surrounding the through opening.

10. The structural component as claimed in claim 1, wherein the profile element has at least one further through opening in the peripheral wall of the profile element opposing the at least one through opening.

11. The structural component as claimed in claim 10, wherein an internal cross section of the at least one further through opening is configured at least in some regions to be smaller than a cross section of the fastening element, and the fastening element bears at least in some regions against an internal wall portion of the profile element surrounding the at least one further through opening.

12. The structural component as claimed in claim 10, wherein the at least one further through opening has an internal cross section through which the at least one fastening element can be introduced into the interior of the profile element.

13. The structural component as claimed in claim 1, wherein the profile element is an internal high pressure-formed tubular element.

14. A method for producing a structural component, optionally a structural component as claimed in claim 1, having the steps:
providing a profile element which has a peripheral wall which at least in some regions delimits an interior of the profile element, and at least one through opening which is provided in the peripheral wall of the profile element,
introducing at least one fastening element into the interior of the profile element and orienting the fastening element with respect to the at least one through opening,
forming at least one material reservoir configured on the profile element and/or on the fastening element for forming a forming portion which positions the fastening element with respect to the through opening.

15. The method as claimed in claim 14, further having the steps:
introducing a forming tool into the at least one through opening
plastic forming of the at least one material reservoir by introducing the forming tool into the at least one through opening,
configuring the forming portion by plastic forming of the material reservoir, wherein the forming portion is configured so as to extend from the peripheral wall of the profile element in the direction of the interior of the profile element.
